(19) United States
(12) Patent Application Publication
(10) Pub. No.: US 2010/0124921 A1
(43) Pub. Date: May 20, 2010

(54) CELLULAR HOME BASE STATION ENABLING LANDLINE CONNECTIVITY

(76) Inventor: Rafy CARMON, Rishon LeZion (IL)

Correspondence Address: The Law Office of Michael E. Kondoudis, 888 16th Street, N.W., Suite 800, Washington, DC, 20006, US

(21) Appl. No.: 12/272,258

(22) Filed: Nov. 17, 2008

(51) Int. Cl. H04W 4/00; H04M 1/00

(52) U.S. Cl. 455/426.1; 455/561; 455/558

(57) ABSTRACT

A landline connectivity module for enabling a cellular home base station (femtocell) operable within a cellular communication network and associated with at least one subscriber identity module (SIM), to connect to a landline phone, the landline connectivity module comprising: an analog to digital (A/D) and digital to analog (D/A) converter; a dual-tone multi-frequency (DTMF) generator and detector/wire-line interface emulator; and an access stratum (AS) interface layer emulator connected to the SIM. The converter receives analog signals from the landline phone and digitally encodes them according to a specific cellular network technology. The DTMF generator and detector/wire-line interface emulator emulates landline phone user interface operations. The AS interface layer emulator assigns the SIM on the cellular network to the at least one landline connected to the cellular base station and further emulates mobile protocol stack operation.

### BACKGROUND

1. Technical Field

The present invention relates to the field of cellular communication networks, and more particularly, to home base stations enabling landline telephone connectivity.

2. Related Art

Prior to setting forth the background of the related art, it may be helpful to set forth definitions of certain terms that will be used hereinafter.

The term “cellular communication network” as used herein in this application, is defined as any radio frequency (RF) based communication network that is based upon geographical partition of space into cells. Each cell is provided with at least one base station that manages the wireless communication therein. Various cellular communication standards are currently in use while other are being developed. The popular ones are: UMTS, HSPA, GSM, CDMA-2000, TD-SCDMA, LTE and WiMAX.

The term “Universal Mobile Telecommunications System” or “UMTS” as used herein in this application, is one of the third-generation (3G) cell phone technologies, which is also being developed through HSPA into a 4G technology. Currently, the most common form of UMTS uses Wideband Code Division Multiple Access (W-CDMA) as the underlying air interface. W-CDMA is a wideband spread-spectrum mobile air interface that utilizes the direct-sequence spread spectrum method of asynchronous code division multiple access to achieve higher speeds and support more users compared to the implementation of time division multiplexing (TDMA) used by 2G GSM networks.

The term “Femtocell” or “Home Base Station” as used herein in this application, is the industry term for a small cellular communication base station, typically designed for use in residential, enterprise or small business environments. The femtocell connects to the service provider's network via broadband Ethernet connection (such as DSL or cable). Current designs typically support two to eight mobile phones simultaneously in a residential setting. A femtocell allows service providers to extend service coverage and capacity indoors, especially where access would otherwise be limited or unavailable. The femtocell incorporates the functionality of a typical base station but extends it to allow a simpler, self contained deployment. By way of example, a UMTS femtocell may contain a Node B, RNC and GSN with Ethernet connection for backhaul. Femtocells may use different communication standards, including UMTS, HSPA, GSM, CDMA-2000, TD-SCDMA, LTE and WiMAX.

The term “landline”, “main line” or “fixed-line” as used herein in this application, relates to a telephone line which travels through a solid medium, usually metal wire on the user's end. This is distinguished from a mobile cellular line, where the medium used between the network equipment (NE) and the user equipment (UE) is the airwaves. Therefore, a landline telephone includes cordless telephone that connects to a landline socket network.

FIG. 1 shows a high level schematic block diagram of a cellular communication base station in communication with a mobile phone (handset). In addition, a separate and independent landline telephone system is shown according to the prior art. In order to establish a communication with a mobile handset 10, home base station 20 comprises: a radio frequency (RF) circuitry and antenna 21; a layer one modem 22; an access stratum (AS) protocol stack 23; a non-access stratum (NAS) protocol interface 24; a backhauling interface 25; and a subscriber identity module (SIM). Mobile handset 10 comprises: a voice encoder/decoder 11; a NAS protocol stack 12; an AS protocol stack 13; a layer one modem 14; and an RF circuitry and antenna.

In operation, an air interface connection is established through modems 14 and 22 and RF circuitries and antennas 15 and 21 on both sides (base station and handset). Voice encoder/decoder 11 and NAS protocol stack 12 are used as peer connections to the cellular core network and are mainly transparent to home base station 20. (AS) protocol stack 23; a non-access stratum (NAS) protocol interface 24 are used in cooperation to convert steams of data received from mobile handset 10 into a data format compliant with the cellular network. These streams of data are in turn backhauled by backhauling interface 25 to the cellular communication network (not shown) via the Ethernet, digital subscriber line (DSL) cable or the like. SIM card 26 is typically used in any home base station so that the cellular communication core network would identify it as a valid node and allow communication therewith.

On the landline branch, a landline phone 34 or a plurality of landline phones 31 and 33 connected to a private branch exchange (PABX) 33 to a landline interface/socket 35 and from there, in turn, to a landline telephony network (not shown).

One of the challenges of the evolving femtocell technology is to offer a comprehensive alternative to telephony coverage of mobile and landline phones alike. Specifically, femtocells deployment provide the cellular network operator with the ability to completely substitute traditional wire line operator by convincing the end user to switch to cellular handsets, such that all indoor voice and data communication would use mobile handsets.

However, due to various practical and psychological reasons, many users are reluctant to completely waive a landline phone. For example, users may prefer to use traditional landline phones because of a better voice quality, and in order to avoid battery and radiation issues. Also, there may be a need for a family/residential static line or identified number with multiple landline phones or a PABX already associated with a common external line. Other reasons may include the fact that landline phones are stationary, always existing in the same place and additionally do not cost as much as mobile handsets. Moreover, small enterprises would prefer to use land phones for inter communication and not provide each employee with a mobile handset. Finally, there are some legacy electronic instruments such as fax machines and answering machines that are incompatible with mobile handsets, thus necessitating a landline interface.

It would be therefore advantageous to provide a solution for introducing landline connectivity into cellular home base stations thus enabling users to switch to femtocell technology without the need to waive landline phones.

### BRIEF SUMMARY

According to one aspect of the invention there is provided a landline connectivity module for enabling a cellular home base station (femtocell) operable within a cellular communication network and associated with at least one subscriber identity module (SIM), to connect to a landline phone, the landline connectivity module comprising: a signal converter; a dual-tone multi-frequency (DTMF) generator and detector/wire-line interface emulator; and an access stratum (AS) interface layer emulator connected to the SIM, wherein the converter receives analog signals from the landline phone and digitally encode them according to a specific cellular network technology; and wherein the DTMF generator and detector/wire-line interface emulator emulates landline phone user interface operations; and wherein the AS interface layer emulator assigns the SIM on the cellular network to the at least one landline connected to the cellular base station and further emulates mobile protocol stack operation.

According to another aspect of the invention there is provided a cellular home base station operable within a cellular communication network and associated with at least one subscriber identity module (SIM) and capable to establish a wireless communication link with a plurality of landline phones, the cellular home base station comprising: a landline connectivity module comprising: a signal converter; a dual-tone multi-frequency (DTMF) generator and detector/wire-line interface emulator; and an access stratum (AS) interface layer emulator connected to the SIM, wherein the converter receives analog signals from the landline phone and digitally encode them according to a specific cellular network technology; and wherein the DTMF generator and detector/wire-line interface emulator emulates landline phone user interface operations; and wherein the AS interface layer emulator assigns the SIM on the cellular network to the at least one landline connected to the cellular base station and further emulates mobile protocol stack operation.

According to yet another aspect of the invention there is provided a method of enabling a cellular communication base station associated with a SIM to connect directly to at least one landline phone, the method comprising: assigning the SIM on the cellular network to the at least one landline connected to the cellular base station; enabling audio/voice compression/decompression between a landline signal from the at least one landline phone and a predefined cellular network format; emulating in a bidirectional manner, the mobile protocol stack operation; and emulating landline phone user interface operations

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram of a cellular communication base station in communication with a mobile handset and a separate landline telephone system according to the prior art;

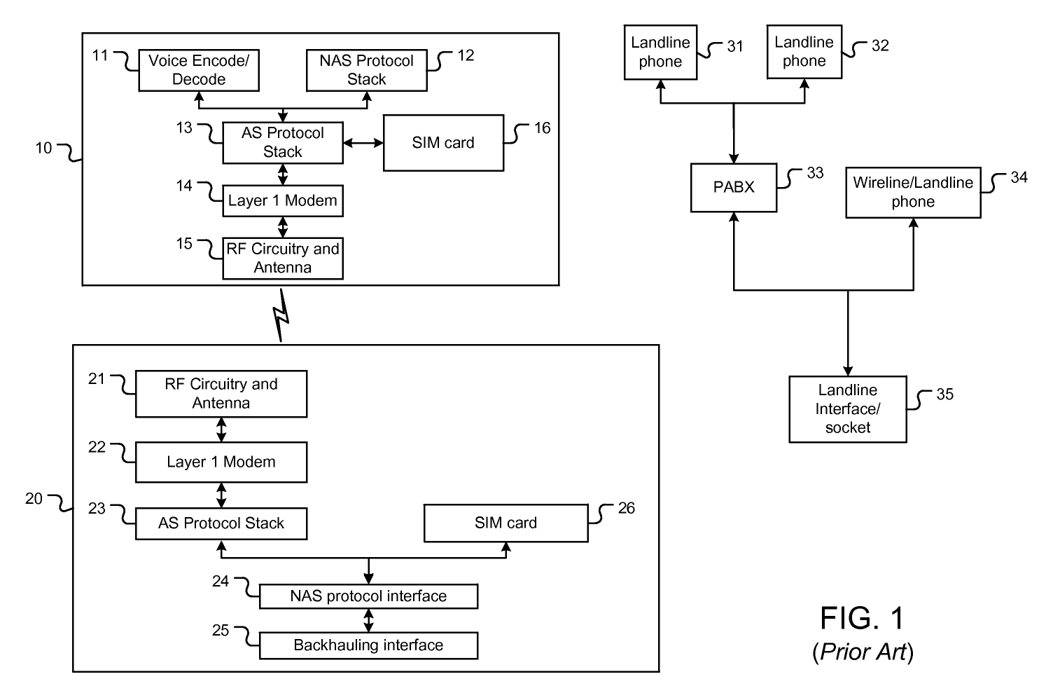

FIG. 2 is a high level schematic block diagram of a cellular communication base station enabling landline connectivity according to an embodiment of the present invention; and

FIG. 3 is a high level flowchart illustrating a method according to some embodiments of the present invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

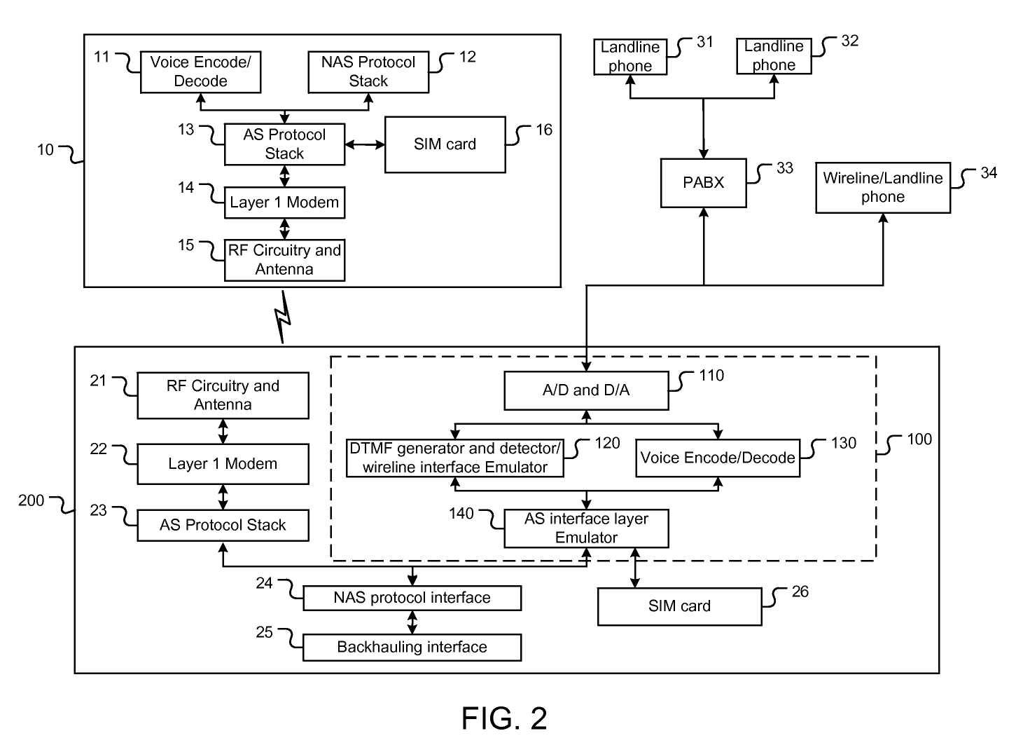

FIG. 2 shows a high level schematic block diagram of a cellular communication base station enabling landline connectivity. Improved home base station 200 comprises: a radio frequency (RF) circuitry and antenna 21; a layer one modem 22; an access stratum (AS) protocol stack 23; a non-access stratum (NAS) protocol interface 24; a backhauling interface 25; and a subscriber identity module (SIM). In addition to the aforementioned components that may be found in traditional cellular home base stations, a landline connectivity module 100 is also provided. Landline connectivity module 100 comprises an analog to digital (A/D) and digital to analog (D/A) converter 110 connected to: a dual-tone multi-frequency (DTMF) generator and detector/wire-line interface emulator 120; and to and a voice encoder/decoder 130. Both DTMF generator and detector/wire-line interface emulator 120 and voice encoder/decoder 130 are connected to an AS interface layer emulator 140 that is connected to SIM card 26; AS protocol stack 23; and non-access stratum (NAS) protocol interface 24.

In operation, an air interface connection is established as in the traditional art through modems 14 and 22 and RF circuitries and antennas 15 and 21 on both sides (base station and handset). Voice encoder/decoder 11 and NAS protocol stack 12 are used as peer connections to the cellular core network and are mainly transparent to home base station 20. (AS) protocol stack 23 and a non-access stratum (NAS) protocol interface 24 are used in cooperation to convert steams of data received from mobile handset 10 into a data format compliant with the cellular core network. These streams of data are in turn backhauled by backhauling interface 25 to the cellular communication network (not shown) via the Ethernet, digital subscriber line (DSL) cable or the like.

In addition to the aforementioned air interface, landline connectivity is enabled by landline connectivity module 100. Landline connectivity module 100 enhances the femtocell functionality by enabling it to establish a direct communication link between traditional landline phone and a landline telephony network via the cellular network. Specifically, home base station 200 with the landline connectivity module may support landline users (phones) transparently, such that these landline phones are regarded by the cellular network as standard mobile users (phones). Landline connectivity module 100 is operable to emulate the landline handset as a wireless mobile as perceived by the cellular network operator (the femtocell operator). In this sense, all landline related communication between home base station 200 and backhaul mobile operator infrastructure will be identical as this was a mobile handset using the air interface to communicate to the femtocell. In addition to the aforementioned functionality, landline connectivity module 100 is further operable to emulate the traditional landline interface towards the landline phone—busy tone, ring tone, call-waiting tone and the like. Thus, home base station 200 behaves as a gateway between traditional landline phones and cellular mobile networks.

Landline connectivity module 100 is configured such that voice encoder/decoder 130 enables audio/voice compression/decompression. Specifically, the analog signals of a landline phone are digitally encoded according to the specific cellular network technology. For example, in 3G the standard would be adaptive multi rate (AMR) vocoder encoding/decoding.

AS interface layer emulator 140 is operable to emulate the mobile protocol stack operation. These operations include: initiating calls, ending calls, and the like. As these message would have been received from a mobile. For example, formatting a number over the landline network—home base station 200 will translate it to a 3G NAS protocol CALL_SETUP message.

DTMF generator and detector/wire-line interface emulator 120 is operable to emulate landline phone operations and specifically the user tones such as busy tone, ring tones, and the like.

In addition, AS interface layer emulator 140, in cooperation with SIM card 26 enable identification of the landlines connected to home base station 200 as valid mobile handsets in the cellular communication network. Specifically, AS interface layer emulator 140 emulates SIM card 26 such that the cellular networks associates each landline and/or PABX connected to home base station 200 as an independent mobile handset having same SIM card.

According to some embodiments, a private PABX 33 supporting N landline users (31, 32) can be connected to home base station 200 through M connections. In this case, PABX 33 functions as if it is connected to regular Telco and additionally, home base station 200 cannot distinguish a PABX from a landline phone.

According to some embodiments, cellular home base station 200 may comprise a plurality of SIM cards, such that each SIM is associated with a single land line phone.

According to some embodiments, home base station 200 enables a fax machine, an answering machine, an audio recorder, a cordless base phone or other analog modems/devices to connect directly thereto.

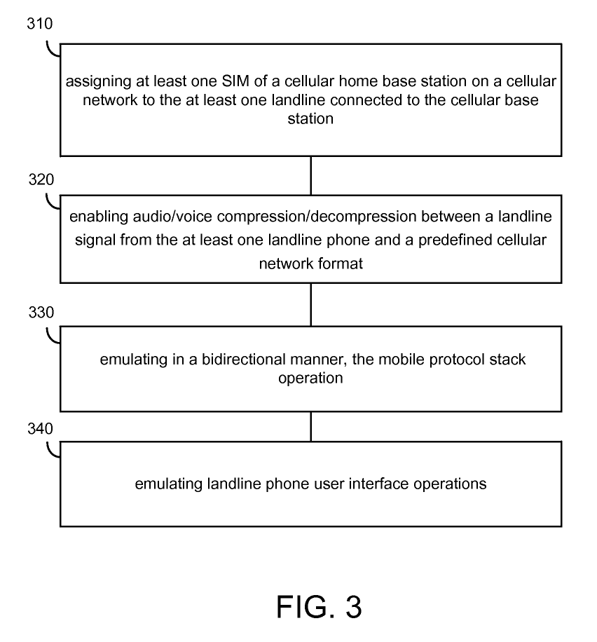

FIG. 3 is a high level flowchart illustrating a method according to some embodiments of the present invention. The flowchart depicts a method of enabling a cellular communication base station having at least one SIM to connect directly to at least one landline phone. The method comprises: assigning cellular base station at least one SIM on the cellular network to the at least one landline connected to the cellular base station 310; enabling audio/voice compression/decompression between a landline signal from the at least one landline phone and a predefined cellular network format 320; emulating in a bidirectional manner, the mobile protocol stack operation 330; and emulating landline phone operations 340.

Advantageously, the addition of landline connectivity functionality to cellular home base stations may be used by cellular networks operators to facilitate the introduction of femtocell technology. Users who are reluctant to switch to mobile telephony altogether may now keep their landline phone while switching to a cellular home base station.

Advantageously, various embodiments of the invention are aimed for the UMTS femtocells market. However, it is understood that the necessary modification may be performed in order to support any kind of cellular communication, in any standard. The functionality of the present invention serves as in cooperation with the femtocell base station control unit within that is arranged to perform all femtocell required activities within a standalone femtocell base station.

According to some embodiments of the invention, the system can be implemented in digital electronic circuitry, or in computer hardware, firmware, software, or in combinations thereof. Preferably, the base band processor with the scalability support functionality is implemented as an application specific integrated circuit (ASIC) thus allowing optimization of the performance while keeping cost relatively low.

Suitable processors modules within the ASIC implementation of the base band processors include, by way of example, digital signal processors (DSPs) but also general purpose microprocessors, and field programmable gate array (FPGA). Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files. Storage devices suitable for tangibly embodying computer program instructions and data include all forms of non-volatile memory, including by way of example semiconductor memory devices, such as EPROM, EEPROM, and flash memory devices.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A landline connectivity module for enabling a cellular home base station that is operable within a particular cellular communication network and operatively associated with at least one subscriber identity module (SIM), to connect to a landline phone, the landline connectivity module comprising:
a signal converter that receives analog signals from the landline phone and digitally encodes the received signals according to a particular format associated with the particular cellular communication network;
a dual-tone multi-frequency (DTMF) generator and detector/wire-line interface emulator that is connected to the converter and that emulates landline phone user interface operations; and
an access stratum (AS) interface layer emulator that is coupled to the at least one SIM, connected to the DTMF generator and detector/wire-line interface emulator, assigns the SIM on the cellular network to at least one landline connected to the cellular base station, and further emulates mobile protocol stack operation.

2. The landline connectivity module according to claim 1, wherein the AS interface layer emulator, in cooperation with SIM card, enable identification of each landline that is connected to home base station as valid mobile handsets in the cellular communication network.

3. The landline connectivity module according to claim 1, wherein the landline connectivity module is connectable to a private branch exchange (PABX), and wherein the SIM is assigned to the PABX such that all landlines connected to the PABX are regarded by the cellular communication network as a single mobile phone.

4. The landline connectivity module according to claim 1, wherein the landline mobile protocol stack operation comprises at least one of initiating a call, switching to another call, and ending a call.

5. The landline connectivity module according to claim 1, wherein the landline connectivity module is operable to emulate the landline phone as a wireless mobile as perceived by the particular cellular communication network.

6. A cellular home base station operable within a particular cellular communication network and operatively associated with at least one subscriber identity module (SIM) and capable to establish a wireless communication link with a plurality of mobile phones, the cellular home base station comprising:
a landline connectivity module comprising: a signal converter that receives analog signals from the landline phone and digitally encodes the received signals according to a particular format associated with the particular cellular communication network; a dual-tone multi-frequency (DTMF) generator and detector/wire-line interface emulator that is connected to the converter and that emulates landline phone user interface operations; and an access stratum (AS) interface layer emulator that is coupled to the at least one SIM, connected to the DTMF generator and detector/wire-line interface emulator, assigns the SIM on the cellular network to at least one landline connected to the cellular base station, and further emulates mobile protocol stack operation.

7. The cellular home base station according to claim 6, wherein the AS interface layer emulator, in cooperation with SIM card, enable identification of each landline that is connected to home base station as valid mobile handsets in the cellular communication network.

8. The cellular home base station according to claim 6, wherein the home base station comprises a plurality of SIM cards, each associated with a single land line phone.

9. The cellular home base station according to claim 6, wherein the land line phone comprises a cordless phone that connects to the line telephone network via a landline socket.

10. The cellular home base station according to claim 6, wherein the landline connectivity module is connectable to a private branch exchange (PABX), and wherein the SIM is assigned to the PABX such that all landline phones connected to the PABX are regarded by the cellular communication network as a single mobile phone.

11. The cellular home base station according to claim 6, wherein landline switching user interface operations comprise detecting and producing busy tone, and detecting and producing ring tones.

12. The cellular home base station according to claim 6, wherein the landline connectivity module is operable to emulate the landline phone as a wireless mobile as perceived by the cellular communication network.

13. A method of enabling a cellular communication base station associated with at least one SIM to connect directly to at least one landline phone, the method comprising:
assigning the at least one SIM on the cellular network to the at least one landline connected to the cellular base station; and
enabling audio/voice compression/decompression between a landline signal from the at least one landline phone and a predefined cellular network format.

14. The method according to claim 13, further comprising emulating in a bidirectional manner, the mobile protocol stack operation.

15. The method according to claim 13, further comprising emulating landline phone user interface operations.
